(19) United States
(12) Patent Application Publication
(10) Pub. No.: US 2025/0155293 A1
(43) Pub. Date: May 15, 2025

(54) BOLOMETER AND BOLOMETER ARRAY

(71) Applicant: NEC Corporation, Tokyo (JP)

(72) Inventors: Tomo Tanaka, Tokyo (JP); Masahiko Sano, Tokyo (JP); Masataka Noguchi, Tokyo (JP); Takashi Miyazaki, Tokyo (JP)

(73) Assignee: NEC Corporation, Tokyo (JP)

(21) Appl. No.: 18/939,926

(22) Filed: Nov. 7, 2024

(30) Foreign Application Priority Data
Nov. 15, 2023 (JP) 2023-194354

(51) Int. Cl. G01J 5/10

(52) U.S. Cl. CPC G01J 5/10; G01J 2005/103; G01J 2005/106

(57) ABSTRACT

A bolometer includes a first electrode, a second electrode sandwiching a meandering interelectrode region with the first electrode, and a sensor portion including a carbon nanotube film that is electrically connected to the first electrode and the second electrode and is provided in the interelectrode region.

### CROSS-REFERENCE TO RELATED APPLICATION

Priority is claimed on Japanese Patent Application No. 2023-194354, filed Nov. 15, 2023, the content of which is incorporated herein by reference.

### BACKGROUND ART

The present disclosure relates to a bolometer and a bolometer array.

As is widely known, a bolometer is used to detect infrared rays.

For example, Japanese Unexamined Patent Application, First Publication No. 2022-25052 (hereinafter referred to as Patent Document 1) discloses a bolometer including a pair of electrodes and a bolometer film that is a carbon nanotube film.

### SUMMARY

In the bolometer disclosed in Patent Document 1, a carbon nanotube film is connected to a pair of electrodes. For this reason, the electrical resistance between the electrodes may be high.

An example object of the present disclosure is to provide a bolometer and a bolometer array for solving the above-described problem.

According to the present disclosure, there is provided a bolometer including: a first electrode; a second electrode sandwiching a meandering interelectrode region with the first electrode; and a sensor portion including a carbon nanotube film that is electrically connected to the first electrode and the second electrode and is provided in the interelectrode region.

According to the above-described example aspect, it is possible to reduce electrical resistance between electrodes.

### BRIEF DESCRIPTION OF THE DRAWINGS

FIG. 1 is a perspective view of a bolometer according to the present disclosure.

FIG. 2 is a cross-sectional view along line II-II of FIG. 1.

FIG. 3 is a perspective plan view of a light receiving portion, a connection portion, and an upper portion of a protective film of the bolometer of FIG. 1.

FIG. 4 is a cross-sectional view along line IV-IV of FIG. 3.

FIG. 5 is a flowchart of a bolometer manufacturing method according to the present disclosure.

FIG. 6 is a cross-sectional view of a bolometer in a manufacturing process in ST01 of the bolometer manufacturing method according to the present disclosure.

FIG. 7 is a cross-sectional view of a bolometer in a manufacturing process in ST02 of the bolometer manufacturing method according to the present disclosure.

FIG. 8 is a cross-sectional view of a bolometer in a manufacturing process in ST03 of the bolometer manufacturing method according to the present disclosure.

FIG. 9 is a cross-sectional view of a bolometer in a manufacturing process in ST04 of the bolometer manufacturing method according to the present disclosure.

FIG. 10 is a cross-sectional view of a bolometer in a manufacturing process in ST05 of the bolometer manufacturing method according to the present disclosure.

FIG. 11 is a cross-sectional view of a bolometer in a manufacturing process in ST06 of the bolometer manufacturing method according to the present disclosure.

FIG. 12 is a cross-sectional view of a bolometer in a manufacturing process in ST07 of the bolometer manufacturing method according to the present disclosure.

FIG. 13 is a cross-sectional view of a bolometer in a manufacturing process in ST08 of the bolometer manufacturing method according to the present disclosure.

FIG. 14 is a cross-sectional view of a bolometer in a manufacturing process in ST09 of the bolometer manufacturing method according to the present disclosure.

FIG. 15 is a cross-sectional view of a bolometer in a manufacturing process in ST10 of the bolometer manufacturing method according to the present disclosure.

FIG. 16 is a cross-sectional view of a bolometer in a manufacturing process in ST11 of the bolometer manufacturing method according to the present disclosure.

FIG. 17 is a cross-sectional view of a bolometer in a manufacturing process in ST12 of the bolometer manufacturing method according to the present disclosure.

FIG. 18 is a cross-sectional view of a bolometer in a manufacturing process in ST13 of the bolometer manufacturing method according to the present disclosure.

FIG. 19 is a cross-sectional view of a bolometer in a manufacturing process in ST14 of the bolometer manufacturing method according to the present disclosure.

FIG. 20 is a cross-sectional view of a bolometer in a manufacturing process in ST101 of a modified example of the bolometer manufacturing method according to the present disclosure.

FIG. 21 is a cross-sectional view of a bolometer in a manufacturing process in ST102 of a modified example of the bolometer manufacturing method according to the present disclosure.

FIG. 22 is a cross-sectional view of a bolometer in a manufacturing process in ST103 of a modified example of the bolometer manufacturing method according to the present disclosure.

FIG. 23 is a cross-sectional view of a bolometer in a manufacturing process in ST104 of a modified example of the bolometer manufacturing method according to the present disclosure.

FIG. 24 is a cross-sectional view of a bolometer in a manufacturing process in ST105 of a modified example of the bolometer manufacturing method according to the present disclosure.

FIG. 25 is a plan view of a bolometer according to the present disclosure.

### EXAMPLE EMBODIMENT

Hereinafter, various example embodiments according to the present disclosure will be described with reference to drawings.

Hereinafter, some example embodiments of the bolometer according to the present disclosure will be described.

### Configuration of Bolometer

The bolometer 9 is a device for detecting infrared rays.

For example, a wavelength band of the infrared rays detected by the bolometer 9 may include 1 to 100 μm.

For example, the wavelength band of the infrared rays detected by the bolometer 9 may include a terahertz band.

The bolometer 9 is, for example, a device constituting each pixel of a bolometer array 99 applied to an uncooled infrared sensor.

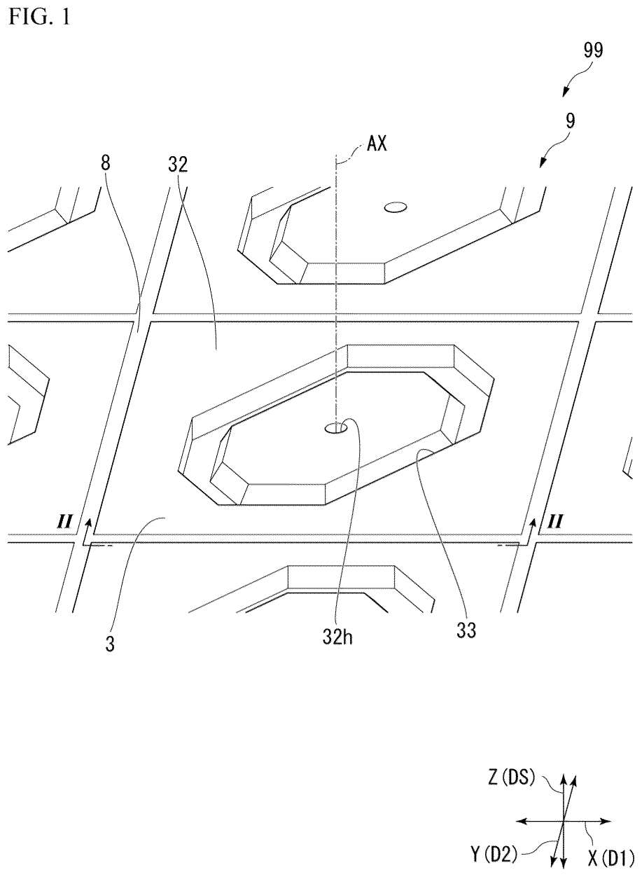

As shown in FIG. 1, the bolometer array 99 includes a plurality of bolometers 9 and a substrate 8.

On the substrate 8, the plurality of bolometers 9 are provided side by side in a plane.

For example, the substrate 8 may include a readout integrated circuit for reading changes in electrical resistance values from the bolometers 9.

For example, the bolometer array 99 may include a sealing member configured to seal the plurality of bolometers 9 so that the periphery of the plurality of bolometers 9 becomes a vacuum.

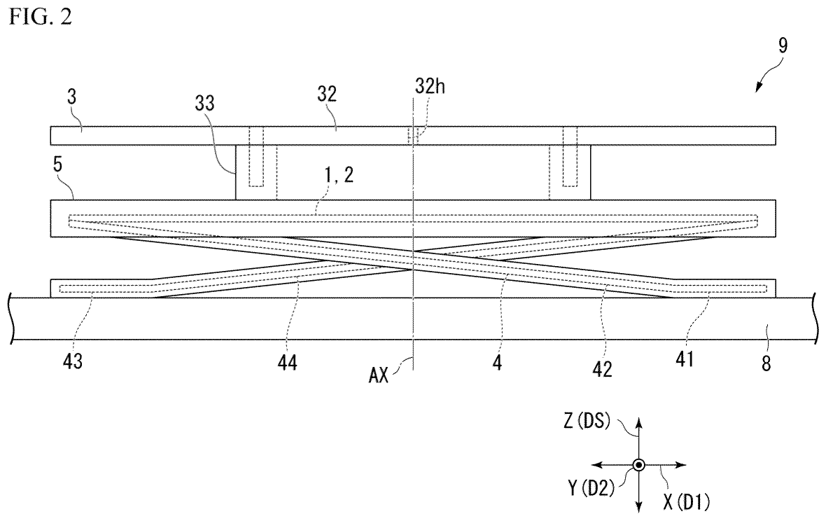

As shown in FIG. 2, each bolometer 9 is arranged on the substrate 8.

The bolometer 9 includes a first electrode 1, a second electrode 2, a sensor portion 3, a wiring portion 4, and a protective film 5.

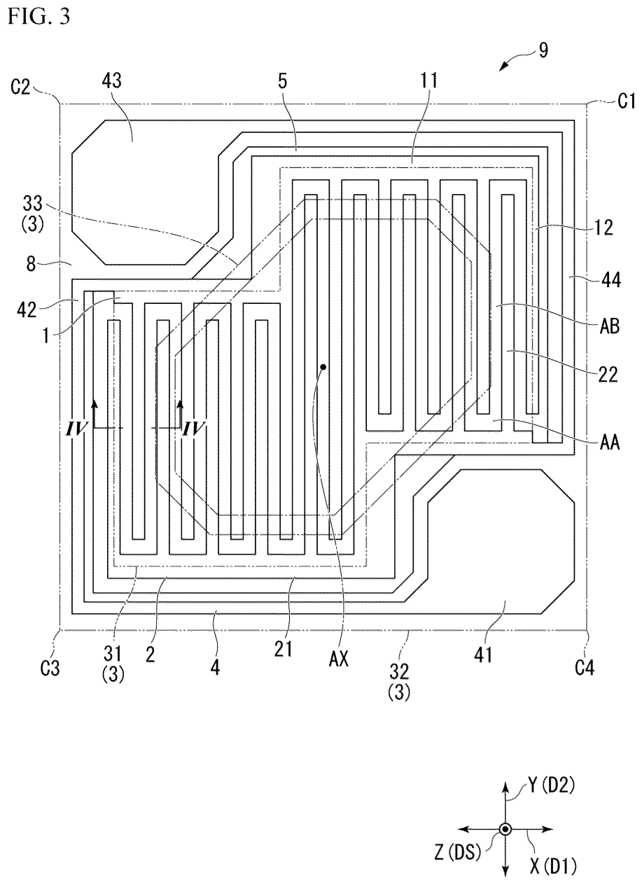

As shown in FIG. 3, constituent elements of the bolometer 9 have a point-symmetrical structure centered on a central axis AX extending in a Z-direction.

A lower limit of an element size of each bolometer 9 is defined by a limit size of a microfabrication process in each bolometer 9 including a meandering shape.

An upper limit of the element size of each bolometer 9 is defined by a limit size for maintaining a hollow structure.

As such an element size, for example, the size of each bolometer 9 in each of an X-direction and a Y-direction, for example, is preferably 10 μm to 50 μm.

In the present disclosure, a first direction DI is also referred to as the X-direction, a second direction D2 is also referred to as the Y-direction, and a lamination direction DS is also referred to as the Z-direction.

The first direction D1, the second direction D2, and the lamination direction DS intersect each other. For example, the first direction D1, the second direction D2, and the lamination direction DS may be orthogonal to each other. For example, an XY plane may be a horizontal plane and the lamination direction DS may be a vertical direction.

In the present example embodiments, an outer circumferential shape of the bolometer 9 is a rectangle having a first corner C1, a second corner C2, a third corner C3, and a fourth corner C4 in order as seen from the Z-direction. In this case, the outer circumferential shape may be rectangular or square.

### Configuration of First Electrode

The first electrode 1 is an electrode for applying an electric current with the second electrode 2 via the sensor portion 3.

The first electrode 1 is provided on the first corner C1 side and the second corner C2 side with respect to the second electrode 2.

The first electrode 1 includes a first base end 11 and a plurality of first extension portions 12.

For example, in the first electrode 1, the first base end 11 and the plurality of first extension portions 12 may be an integral pattern.

For example, the first electrode 1 may include nine first extension portions 12.

The first electrode 1 is formed of a conductive material such as aluminum, copper, gold, or TiAlV.

The first base end 11 is provided on the first corner C1 side and the second corner C2 side with respect to the central axis AX in the second direction D2.

The first base end 11 extends in the first direction DI while bending once in the second direction D2 in the middle to avoid the second corner C2.

A size of the first base end 11 may be any size within an appropriate range based on the compatibility of microfabrication performance and effective resistance reduction performance.

For example, a width of the first base end 11 is 1% to 40% of the element size of the bolometer 9, preferably 3 to 20%.

Each of the plurality of first extension portions 12 protrudes from the first base end 11 in the second direction D2.

For example, the plurality of first extension portions 12 may be arranged in parallel at equal intervals in the first direction D1.

A size of each first extension portion 12 may be any size within an appropriate range based on the compatibility of microfabrication performance and effective resistance reduction performance. Moreover, the number of first extension portions 12 may be any number within an appropriate range based on the compatibility of microfabrication performance and effective resistance reduction performance. For example, a width of each first extension portion 12 is 0.2 μm to 20 μm, preferably 0.2 μm to 1 μm.

For example, a length of each first extension portion 12 is 20% to 99% of the element size of the bolometer 9, preferably 30 to 70%.

For example, the number of first extension portions 12 is 2 to 30, preferably 5 to 15.

### Configuration of Second Electrode

The second electrode 2 is an electrode for applying an electric current with the first electrode 1 via the sensor portion 3.

The second electrode 2 is separated from the first electrode 1 in the XY plane.

The second electrode 2 is provided on the third corner C3 side and the fourth corner C4 side with respect to the first electrode 1 in the second direction D2.

The second electrode 2 includes a second base end 21 and a plurality of second extension portions 22.

For example, in the second electrode 2, the second base end 21 and the plurality of second extension portions 22 may be an integral pattern.

For example, the second electrode 2 may include nine second extension portions 22.

The second electrode 2 is separately provided to sandwich an interelectrode region AA with the first electrode 1.

The interelectrode region AA has a meandering shape in the XY plane.

In the present disclosure, “meandering shape” refers to an undulating shape. This includes an undulation and an extension and is also referred to as an “extension in a meandering shape” in the present disclosure.

For example, the interelectrode region AA extends in the first direction D1 while repeating the bending from one side of the second direction D2 to the other side thereof and the bending from the other side of the second direction D2 to the one side thereof at an end extending in the second direction D2.

The second electrode 2 is formed of a conductive material such as aluminum, copper, gold, or TiAlV.

The second base end 21 is provided on the third corner C3 side and the fourth corner C4 side with respect to the central axis AX in the second direction D2.

The second base end 21 extends in the first direction D1 while bending once in the second direction D2 in the middle to avoid the fourth corner C4.

Portions of the second base end 21 extending in the first direction D1 and portions of the first base end 11 extending in the first direction DI are opposite each other in the second direction D2.

A size of the second base end 21 may be any size within an appropriate range based on the compatibility of microfabrication performance and effective resistance reduction performance.

For example, a width of the second base end 21 is 1% to 40% of the element size of the bolometer 9, preferably 3 to 20%.

The plurality of second extension portions 22 protrude from the second base end 21 in the second direction D2 between the first extension portions 12.

For example, the plurality of second extension portions 22 may be arranged parallel to the first direction D1 at equal intervals.

A size of each second extension portion 22 may be any size within an appropriate range based on the compatibility of microfabrication performance and effective resistance reduction performance. Moreover, the number of second extension portions 22 may be any number within an appropriate range based on the compatibility of microfabrication performance and effective resistance reduction performance.

For example, a width of each second extension portion 22 is 0.2 μm to 20 μm, preferably 0.2 μm to 1 μm.

For example, a length of each second extension portion 22 is 20% to 99% of the element size of the bolometer 9, preferably 30 to 70%.

For example, the number of second extension portions 22 is 2 to 30, preferably 5 to 15.

Each of the plurality of second extension portions 22 linearly extends toward the first base end 11 up to just before the first base end 11. On the other hand, each of the plurality of first extension portions 12 linearly extends toward the second base end 21 up to just before the second base end 21.

Each of the plurality of second extension portions 22 extends between a pair of first extension portions 12 configured to sandwich both sides of the second extension portion 22 among the plurality of first extension portions 12 so that the second extension portion 22 crosses the pair of first extension portions 12.

With such a configuration, the first electrode 1 and the second electrode 2 have a structure in which the plurality of first extension portions 12 and the plurality of second extension portions 22 mesh together as a whole.

Moreover, in a gap of this meshed structure, the interelectrode region AA is defined.

For example, a width of the interelectrode region AA may be 500 nm or more and 3 μm or less.

In the present disclosure, “width of the interelectrode region AA” refers to a length of the interelectrode region AA in a direction facing electrodes that are the first electrode 1 and the second electrode 2.

### Configuration of Sensor Portion

The sensor portion 3 is a sensor for receiving infrared rays and detecting a quantity related to an intensity of the received infrared rays as a quantity of change in the electrical resistance value.

The sensor portion 3 has a function of converting the received infrared rays into heat and changing an electrical resistance value between the first electrode 1 and the second electrode 2 in relation to the heat after the conversion.

The sensor portion 3 includes a carbon nanotube film 31, a light receiving portion 32, and a connection portion 33.

### Configuration of Carbon Nanotube Film

The carbon nanotube film 31 functions as an electrical resistor whose electrical resistance value changes in relation to the heat.

The carbon nanotube film 31 is electrically connected to the first electrode 1 and the second electrode 2 in the interelectrode region AA.

The carbon nanotube film 31 is electrically connected to the first electrode 1 and the second electrode 2 across the entire interelectrode region AA along the interelectrode region AA.

For example, the entire interelectrode region AA may be filled with the carbon nanotube film 31, and therefore the carbon nanotube film 31 extends in the interelectrode region AA in a meandering shape.

Specifically, the carbon nanotube film 31 is electrically connected to the plurality of first extension portions 12 and the plurality of second extension portions 22 in at least a plurality of gap regions AB within the interelectrode region AA by extending in a meandering shape.

Here, the plurality of gap regions AB are regions formed between the plurality of first extension portions 12 and the plurality of second extension portions 22 in the meandering interelectrode region AA and are regions extending in the second direction D2.

In addition, the carbon nanotube film 31 is electrically connected to the tip of the plurality of first extension portions 12 and the second base end 21 and electrically connected to the tip of the plurality of second extension portions 22 and the first base end 11, even in the portion where the plurality of gap regions AB are connected in the first direction D1.

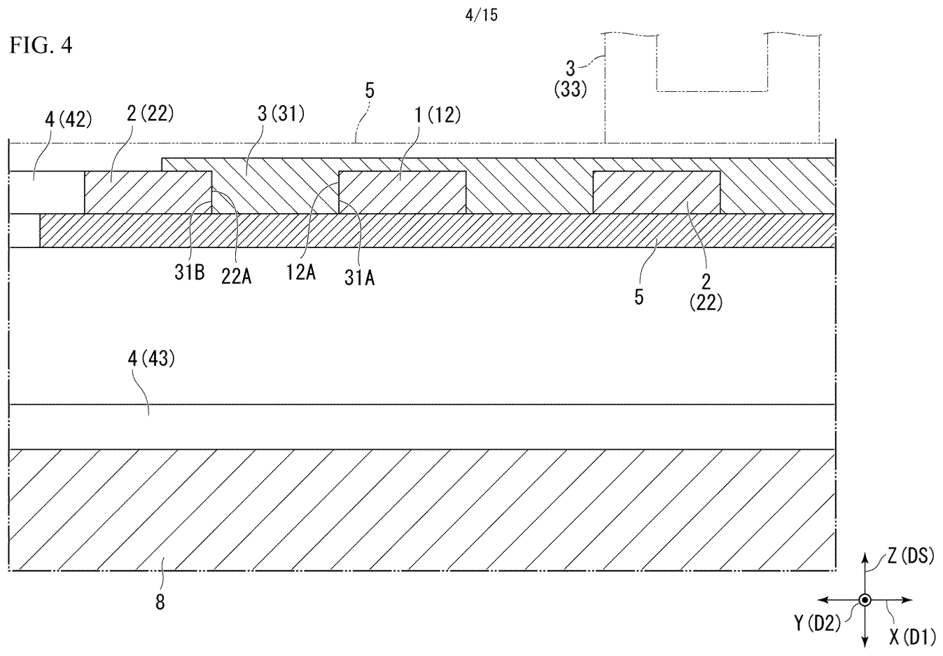

As shown in FIG. 4, the carbon nanotube film 31 has a first film side surface 31A and a second film side surface 31B.

The first film side surface 31A extends along the interelectrode region AA and is in contact with the first electrode side surface 12A facing the first direction DI as the first electrode side surface 12A of each first extension portion 12 in the first electrode 1.

The second film side surface 31B extends along the interelectrode region AA and is in contact with the second electrode side surface 22A facing the first direction D1 as the second electrode side surface 22A of each second extension portion 22 in the second electrode 2.

For example, the carbon nanotube film 31 may be connected by an upper layer of the plurality of first extension portions 12 and the plurality of second extension portions 22 to cover an upper surface of the plurality of first extension portions 12 and the plurality of second extension portions 22.

For example, the carbon nanotube film 31 may also be in contact with side surfaces of the first base end 11 and the second base end 21 which face each other and each of which faces the second direction D2.

For example, a thickness of the carbon nanotube film 31 may be preferably 0.7 nm or more and 50 nm or less, more preferably 0.7 nm or more and 10 nm or less, and more preferably 0.7 nm or more and 5 nm or less.

For example, the carbon nanotube film 31 may include single-layer carbon nanotubes.

For example, the carbon nanotube film 31 may include semiconductor-type carbon nanotubes.

For example, the carbon nanotube film 31 may contain preferably 80% or more of the semiconductor-type carbon nanotubes and more preferably 90% or more of the semiconductor-type carbon nanotubes.

For example, the carbon nanotube film 31 may include semiconductor-type carbon nanotubes extracted by an electric-field-induced layer formation (ELF) method. Although the carbon nanotube film 31 may include semiconductor-type carbon nanotubes extracted by another method, it is preferable to include semiconductor-type carbon nanotubes extracted by the ELF method. In this case, for example, a nonionic surfactant may be used in the ELF method for extracting semiconductor-type carbon nanotubes because there is less negative effect on the electrical characteristics of the bolometer 9.

For example, the length of one semiconductor carbon nanotube separated by the ELF method may be 10 nm to 1 μm.

For example, in the carbon nanotube film 31, semiconductor-type carbon nanotubes may be bundled. In this case, a length of a bundle of semiconductor-type carbon nanotubes may be about 100 nm to 10 μm.

For example, the carbon nanotube film 31 may include a carbon nanotube network film in which a plurality of carbon nanotubes are randomly oriented and form a network with each other.

In the present disclosure, the term “carbon nanotube network film” refers to a carbon nanotube film in which a plurality of carbon nanotubes are randomly oriented and form a network with each other.

### Configuration of Light Receiving Portion

As shown in FIGS. 1 and 2, the light receiving portion 32 is a thin film separated from the protective film 5 at the upper part of the bolometer 9 and spreading in a roof shape in the XY plane above the protective film 5.

The light receiving portion 32 covers one surface side of a region including the carbon nanotube film 31, the first electrode 1, and the second electrode 2.

For example, the light receiving portion 32 may cover an upper surface side of the region including the carbon nanotube film 31, the first electrode 1, and the second electrode 2. Moreover, a region covered by the light receiving portion 32 may further include the wiring portion 4.

For example, the light receiving portion 32 may have a plate shape having the XY plane as a plate surface, except for a portion where the connection portion 33 is located.

For example, the position of the light receiving portion 32 in the Z-direction may be a position adjusted according to a wavelength and reflection position of the infrared rays transmitted through the light receiving portion 32 and reflected from the substrate 8 side.

For example, the outer circumferential shape of the light receiving portion 32 may be rectangular or square.

For example, the light receiving portion 32 may have a through hole 32h on the central axis AX.

The light receiving portion 32 is formed of a material having the function of converting the received infrared rays into heat, such as silicon nitride or titanium nitride.

### Configuration of Connection Portion

The connection portion 33 extends from the light receiving portion 32 to the carbon nanotube film 31 in the lamination direction DS.

The connection portion 33 supports the light receiving portion 32 above the carbon nanotube film 31, the first electrode 1, and the second electrode 2.

An upper end of the connection portion 33 is thermally connected to the light receiving portion 32.

A lower end of the connection portion 33 is thermally connected to the carbon nanotube film 31 via the protective film 5 by contacting the upper surface of the protective film 5. Further, the connection portion 33 may be further thermally connected to the first electrode 1 and the second electrode 2 via the protective film 5.

Specifically, the lower end of the connection portion 33 may be in contact with a portion of the upper surface of the protective film 5 provided across the upper surface of the carbon nanotube film 31, the upper surface of the first electrode 1, and the upper surface of the second electrode 2.

For example, the connection portion 33 may have an upper surface recessed in the downward direction from the light receiving portion 32 and a lower surface protruding in the downward direction in relation to the upper surface, and therefore may be recessed and extended toward the carbon nanotube film 31. For example, the connection portion 33 may be recessed in an octagonal ring shape having a long axis in the direction in which the first corner C1 and the third corner C3 are connected as seen from the Z-direction.

For example, the connection portion 33 may be integrally formed of a material similar to that of the light receiving portion 32.

### Composition of Wiring Portion

As shown in FIGS. 2 and 3, the wiring portion 4 includes a first contact portion 41, first wiring 42, second contact portion 43, and second wiring 44.

The wiring portion 4 supports the first electrode 1, the second electrode 2, and the sensor portion 3 in the air so that the first electrode 1, the second electrode 2, and the sensor portion 3 are separated from the substrate 8.

For example, the first contact portion 41, the first wiring 42, and the first electrode 1 may be thin films integrated with each other.

Likewise, the second contact portion 43, the second wiring 44, and the second electrode 2 may be an integral thin film.

The first contact portion 41 is provided on the second electrode 2 side with respect to the first electrode 1. Specifically, the first contact portion 41 is provided at a position closer to the fourth corner C4 than the first corner C1, the second corner C2, and the third corner C3 as a position close to the fourth corner C4 from the central axis AX.

The first wiring 42 extends to connect the first base end 11 and the first contact portion 41. Specifically, the first wiring 42 extends from the first base end 11 to the first contact portion 41 through the vicinity of the third corner C3 along two sides sandwiching the third corner C3 among four sides of the outer periphery of the bolometer 9.

The second contact portion 43 is provided on the first electrode 1 side with respect to the second electrode 2. Specifically, the second contact portion 43 is provided at a position closer to the second corner C2 than the first corner C1, the third corner C3, and the fourth corner C4 as a position close to the second corner C2 from the central axis AX.

The second wiring 44 extends to connect the second base end 21 and the second contact portion 43. Specifically, the second wiring 44 extends from the second base end 21 to the second contact portion 43 through the vicinity of the first corner Cl along the two sides sandwiching the first corner Cl among the four sides of the outer periphery of the bolometer 9.

The wiring portion 4 is formed of a conductive material such as aluminum, copper, gold, or TiAlV.

### Configuration of Protective Film

The protective film 5 integrally covers the first electrode 1, the second electrode 2, the carbon nanotube film 31, and the wiring portion 4.

The protective film 5 is an insulator such as silicon nitride, silicon oxide, or resin.

### Operation of Bolometer

An operation of the bolometer 9 of the present example embodiments will be described.

In a case where infrared rays are incident on the bolometer 9 and absorbed, heat is generated. For example, in a case where the light receiving portion 32 absorbs infrared rays, heat is generated in the light receiving portion 32. The generated heat is transferred through the connection portion 33 and warms the carbon nanotube film 31 via the protective film 5.

In a case where the carbon nanotube film 31 is warmed, the electrical resistance value of the carbon nanotube film 31 changes.

The bolometer 9 electrically detects a change in the electrical resistance value of the carbon nanotube film 31 in the interelectrode region AA by causing an electric current to flow between the first electrode 1 and the second electrode 2, and detects infrared rays.

### Operation and Effects

According to the bolometer 9 of the present example embodiments, the interelectrode region AA in which the carbon nanotube film 31 is electrically connected has a meandering shape. Thereby, an electrical resistor of carbon nanotubes having a small length in the direction facing the electrodes and a large length in a direction intersecting the direction facing the electrodes can be formed between the first electrode 1 and the second electrode 2.

Therefore, the electrical resistance between the first electrode 1 and the second electrode 2 can be reduced.

As a comparative example, a bolometer using a vanadium oxide film as an electrical resistor is given. A temperature coefficient of resistance (TCR) of the bolometer in such a comparative example is small as about 2%/K. Moreover, in the bolometer of the comparative example, three strip-shaped electrical resistors are connected in series between wiring portions to adjust an electrical resistance value.

On the other hand, the TCR of a bolometer using a carbon nanotube network film as an electrical resistor can have, for example, about 5%/K to 10%/K. For this reason, in the bolometer of the comparative example, if an electrical resistor of a carbon nanotube network film is used instead of an electrical resistor of a vanadium oxide film, a bolometer with higher detection capability is likely to be made. However, the sheet resistance of the carbon nanotube network film is extremely greater than that of the vanadium oxide film. For this reason, in a case where a structure in which strip-shaped electrical resistors are connected in series is applied to a bolometer using a carbon nanotube network film in an electrical resistor, the electrical resistance significantly increases.

Compared with this comparative example, in the bolometer 9 of the present example embodiments, the interelectrode region AA in which the carbon nanotube film 31 is electrically connected has a meandering shape and the electrical resistance between the first electrode 1 and the second electrode 2 can be reduced as described above. Therefore, it is possible to achieve both the improvement of TCR and the reduction of electrical resistance.

Moreover, according to the present example embodiments, the carbon nanotube film 31 is electrically connected to the plurality of first extension portions 12 and the plurality of second extension portions 22 in at least the plurality of gap regions AB. Thereby, the carbon nanotube film 31 is electrically connected to the plurality of first extension portions 12 and the plurality of second extension portions 22 across many regions in the interelectrode region AA.

Therefore, the electrical resistance between the first electrode 1 and the second electrode 2 can be reduced.

Moreover, according to the present example embodiments, the light receiving portion 32 covers a side surface of the region including the carbon nanotube film 31, the first electrode 1, and the second electrode 2. In a case where the interelectrode region AA has a meandering shape, an area occupied by the first electrode 1 and the second electrode 2 tends to increase and an area occupied by the carbon nanotube film 31 tends to decrease. On the other hand, in the present example embodiments, because this light receiving portion 32 is provided, the light receiving area of the bolometer 9 can be secured regardless of the decrease in the area occupied by the carbon nanotube film 31.

Therefore, a decrease in a fill factor of the bolometer 9 can be suppressed.

In particular, in a material with a large electrical resistance value such as a carbon nanotube film 31, it is necessary to increase the meandering undulation in the interelectrode region AA as much as possible and increase the length in a direction intersecting the interelectrode direction. For this reason, the area occupied by the first electrode 1 and the second electrode 2 becomes larger and the area occupied by the carbon nanotube film 31 becomes smaller.

For this reason, in the bolometer 9 using the carbon nanotube film 31 as shown in the present example embodiments, the light receiving portion 32 that provides the effect of securing a light receiving area is useful.

Moreover, according to the present example embodiments, because the first electrode side surface 12A of the carbon nanotube film 31 is in contact with the first electrode 1 and the second electrode side surface 22A is in contact with the second electrode 2, the carbon nanotube film 31 is electrically connected to the first electrode 1 and the second electrode 2 across the first electrode side surface 12A and the second electrode side surface 22A.

Therefore, the electrical resistance between the first electrode 1 and the second electrode 2 can be reduced.

Moreover, according to the present example embodiments, the carbon nanotube film 31 extends in the interelectrode region AA in a meandering shape. Thereby, an electrical resistor of carbon nanotubes having a small length in a direction between the electrodes and a large length in a direction intersecting the direction between the electrodes can be formed between the first electrode 1 and the second electrode 2.

Therefore, the electrical resistance between the first electrode 1 and the second electrode 2 can be reduced.

Moreover, according to the present example embodiments, the carbon nanotube film 31 includes a carbon nanotube network film. Thereby, the TCR of the bolometer 9 can be increased.

Therefore, the sensitivity of the infrared rays of the bolometer 9 can be increased.

Moreover, according to the present example embodiments, a width of the interelectrode region AA is 500 nm or more and 3 μm or less.

If the width of the interelectrode region AA is set in this range, both a large TCR and a small electrical resistance value can be achieved in the carbon nanotube film 31 including the carbon nanotube network film. Specifically, this will be described below.

In general, in a bolometer, the electrical resistance value tends to decrease in a case where the distance between the electrodes is shortened and the TCR tends to increase in a case where the distance between the electrodes is increased.

On the other hand, in a bolometer in which the electrodes are electrically connected by a carbon nanotube film, in a case where the distance between the electrodes is extremely shortened, an electric current flowing through metallic carbon nanotubes contained in a small amount becomes dominant and the TCR tends to deteriorate extremely. For example, the length of carbon nanotubes obtained by the ELF method is about 300 nm or less. Because electrons can move relatively freely between one end and the other end of a single metallic carbon nanotube, if there are many metallic carbon nanotubes with both of these ends in contact with the first electrode and the second electrode, it is conceivable that an electric current flowing therethrough in the film will become dominant.

For this reason, if the width of the interelectrode region AA is 500 nm or more, because metallic carbon nanotubes whose both ends reach both the first electrode and the second electrode are substantially eliminated, the bolometer 9 can maintain a large TCR.

On the other hand, in a case where a carbon nanotube network film is formed using a carbon nanotube obtained by the ELF method and a silane coupling agent such as 3-aminopropyltriethoxysilane (APTES), it is known that the carbon nanotubes are locally oriented.

In this case, a size of a domain, which is a region in which the orientation of the carbon nanotubes is aligned to some extent, is about 3 μm at most. For this reason, because the width of the interelectrode region AA is smaller than the size of this domain, a decrease in the electrical resistance value between the electrodes can be expected.

In practice, the orientation of the carbon nanotubes in the domain is somewhat random, but carbon nanotubes with an orientation favorable to the reduction of electrical resistance are present in the interelectrode region AA by increasing the length of the extension of the interelectrode region AA.

For this reason, if the width of the interelectrode region AA is 3 μm or less, the electrical resistance between the first electrode 1 and the second electrode 2 can be reduced.

Moreover, according to the present example embodiments, the wiring portion 4 includes the first contact portion 41 provided on the second electrode 2 side and the first wiring 42 connecting the first electrode 1 and the first contact portion 41. Further, the wiring portion 4 includes the second contact portion 43 provided on the first electrode 1 side and the second wiring 44 connecting the second electrode 2 and the second contact portion 43.

Thereby, the first wiring 42 and the second wiring 44 can be compactly configured and the first wiring 42 and the second wiring 44 can be configured in a long length.

For this reason, the dissipation of the heat after conversion can be suppressed.

Therefore, a decrease in the sensitivity of infrared rays can be suppressed.

Moreover, according to the present example embodiments, because the wiring portion 4 supports the first electrode 1, the second electrode 2, and the carbon nanotube film 31, the dissipation of the heat after conversion can be suppressed.

Therefore, a decrease in the sensitivity of infrared rays can be suppressed.

Moreover, according to an example of the present example embodiments, the light receiving portion 32 is separated from the substrate 8 across a wide range of a plate-shaped portion other than a portion where the connection portion 33 is located. With such a structure, the light receiving portion 32 can absorb some of the infrared rays emitted from above in the wide range of the plate-shaped portion and absorb infrared rays reflected from the substrate 8 side again in a wide range of the plate-shaped portion among the remaining infrared rays that are transmitted. Therefore, the light receiving portion 32 has a structure capable of absorbing a large amount of infrared rays.

Moreover, according to an example of the present example embodiments, the connection portion 33 is recessed in an octagonal ring shape having a long axis in a direction in which the first corner C1 and the third corner C3 are connected as seen from the Z-direction. With such a structure, the connection portion 33 can support the light receiving portion 32 in a well-balanced manner and can widely transmit heat to the meandering interelectrode region AA.

### Modified Example

Although the sensor portion 3 includes the light receiving portion 32 and the connection portion 33 in the present example embodiments, the sensor portion 3 may be configured in any way as long as infrared rays can be detected.

As a modified example, in a case where a decrease in the area occupied by the carbon nanotube film 31 is not an issue, the sensor portion 3 may be configured to detect infrared rays in a case where the carbon nanotube film 31 or the protective film 5 converts infrared rays into heat without including the light receiving portion 32 and the connection portion 33.

In an example of the present example embodiments, the carbon nanotube film 31 is electrically connected to the first electrode 1 and the second electrode 2 across the entire interelectrode region AA along the interelectrode region AA. However, the carbon nanotube film 31 may be configured in any way as long as the carbon nanotube film 31 is electrically connected to the first electrode 1 and the second electrode 2 in the interelectrode region AA.

As a modified example, the carbon nanotube film 31 may be electrically connected to the first electrode 1 and the second electrode 2 across a partial region of the meandering interelectrode region AA.

As another modified example, the carbon nanotube film 31 may be electrically connected to the first electrode 1 and the second electrode 2 only in the plurality of gap regions AB in the meandering interelectrode region AA.

On the other hand, in more portions of the meandering interelectrode region AA, as the carbon nanotube film 31 is electrically connected to the first electrode 1 and the second electrode 2, the electrical resistance between the first electrode 1 and the second electrode 2 is further reduced.

In an example of the present example embodiments, the carbon nanotube film 31 is in contact with the first electrode side surface 12A and the second electrode side surface 22A. However, the carbon nanotube film 31 may be configured in any way as long as the carbon nanotube film 31 is electrically connected to the first electrode 1 and the second electrode 2 in the interelectrode region AA.

As a modified example, the carbon nanotube film 31 may be electrically connected to the upper surface of the first electrode 1 and the upper surface of the second electrode 2 above the first electrode side surface 12A and the second electrode side surface without contact with the first electrode side surface 12A and the second electrode side surface 22A.

On the other hand, the carbon nanotube film 31 tends to reduce the electrical resistance between the first electrode 1 and the second electrode 2 in a case where the carbon nanotube film 31 is in contact with the first electrode side surface 12A and the second electrode side surface 22A.

Although the first electrode 1 and the second electrode 2 include nine first extension portions 12 and nine second extension portions 22 in an example of the present example embodiments, the first electrode 1 and the second electrode 2 may be configured in any way if they can be configured in the meandering interelectrode region AA.

As a modified example, each of the number of first extension portions 12 and the number of second extension portions 22 may be 2 or more and less than 9.

As another modified example, each of the number of first extension portions 12 and the number of second extension portions 22 may be 10 or more.

Although the plurality of first extension portions 12 and the plurality of second extension portions 22 are evenly spaced in the X-direction in an example of the present example embodiments, the plurality of first extension portions 12 and the plurality of second extension portions 22 may be configured in any way if the interelectrode region AA can be configured in a meandering shape.

As a modified example, the plurality of first extension portions 12 may be arranged at different intervals in the X-direction.

As another modified example, the plurality of second extension portions 22 may be arranged at different intervals in the X-direction.

Although the plurality of first extension portions 12 are arranged parallel in the X-direction in an example of the present example embodiments, they do not necessarily have to be parallel if the interelectrode region AA can be configured in a meandering shape.

Likewise, although the plurality of second extension portions 22 are arranged parallel in the X-direction in an example of the present example embodiments, the plurality of second extension portions 22 may not necessarily be parallel if the interelectrode region AA can be configured in a meandering shape.

Although each of the plurality of second extension portions 22 linearly extends in an example of the present example embodiments, each second extension portion 22 may be curved even if it is not necessarily linear in a case where it protrudes in the second direction D2.

Likewise, although each of the plurality of second extension portions 22 linearly extends in an example of the present example embodiments, each second extension portion 22 may be curved in the middle even if it is not necessarily linear in a case where it protrudes in the second direction D2.

In an example of the present example embodiments, the connection portion 33 is recessed in an octagonal ring shape from the light receiving portion 32 as seen from the Z-direction. However, the connection portion 33 can be configured in any way as long as the connection portion 33 can support the light receiving portion 32 on the carbon nanotube film 31, the first electrode 1, and the second electrode 2 and the connection portion 33 thermally connects the carbon nanotube film 31, the first electrode 1, the second electrode 2, and the light receiving portion 32.

As a modified example, the connection portion 33 may be recessed in a ring shape such as a polygon, an oval, or a perfect circle from the light receiving portion 32 as seen from the Z-direction.

As another modified example, the connection portion 33 may have a prismatic shape or a cylindrical shape extending downward from the light receiving portion 32.

Hereinafter, some example embodiments of the method of manufacturing a bolometer according to the present disclosure will be described.

Although the bolometer manufactured by the manufacturing method of the present example embodiment is the same as the bolometers 9 of some example embodiments described above in that a first electrode, a second electrode, a sensor portion, a wiring portion, and a protective film are provided, a specific structure is different from those of the bolometers 9 of some example embodiments described above, except for the following points.

### Process of Manufacturing Method

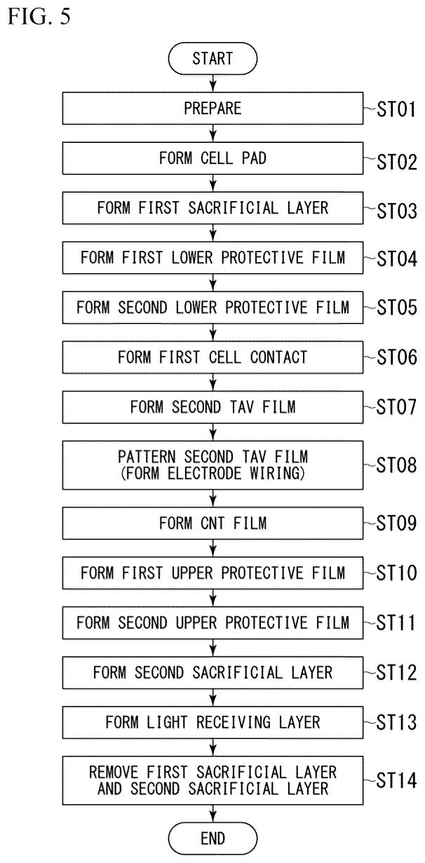

In the manufacturing method of the present example embodiments, the steps of ST01 to ST14 are performed as shown in FIG. 5.

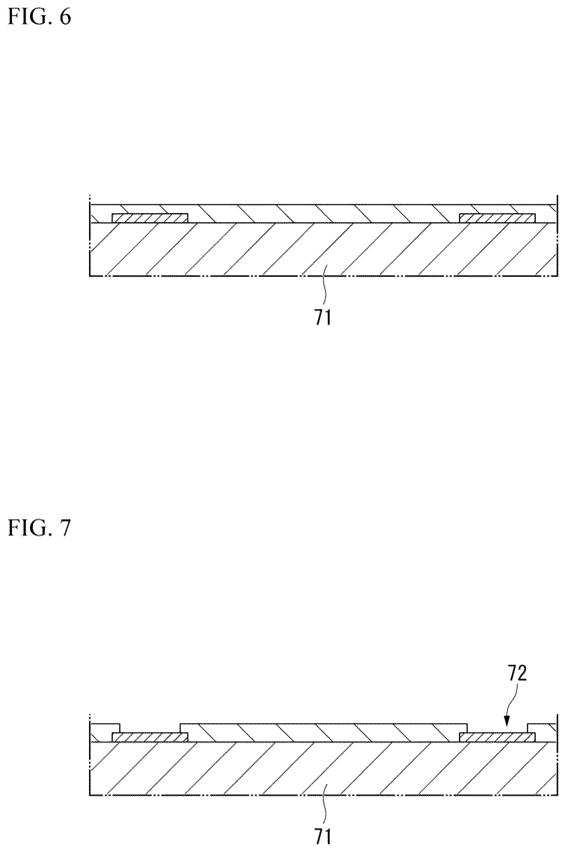

First, as shown in FIG. 6, the manufacturer prepares the substrate 71 (ST01).

After the implementation of ST01, the manufacturer forms a cell pad 72 on the substrate 71 as shown in FIG. 7 (ST02).

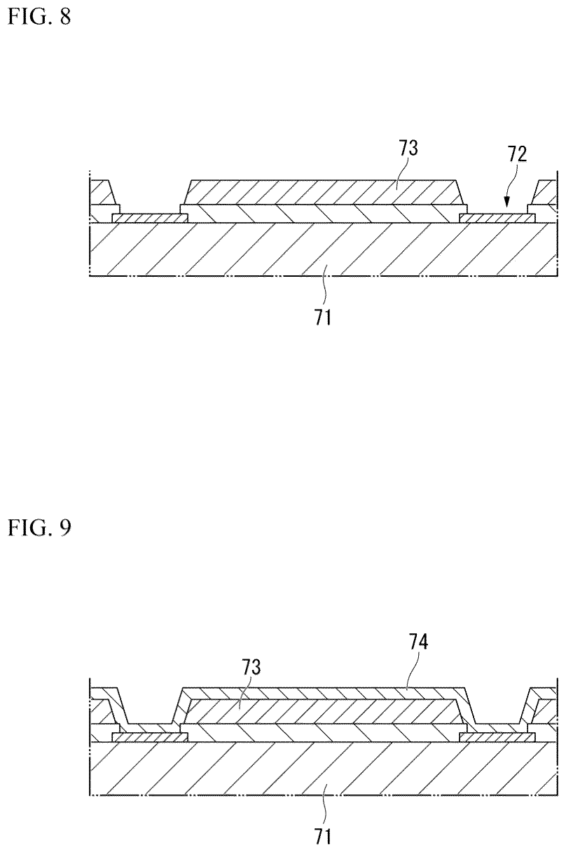

After the implementation of ST02, the manufacturer forms a first sacrificial layer 73 on the substrate 71 as shown in FIG. 8 (ST03).

After the implementation of ST03, the manufacturer forms a first lower protective film 74 on the first sacrificial layer 73 as shown in FIG. 9 (ST04). For example, the first sacrificial layer 73 is formed of organic polyimide.

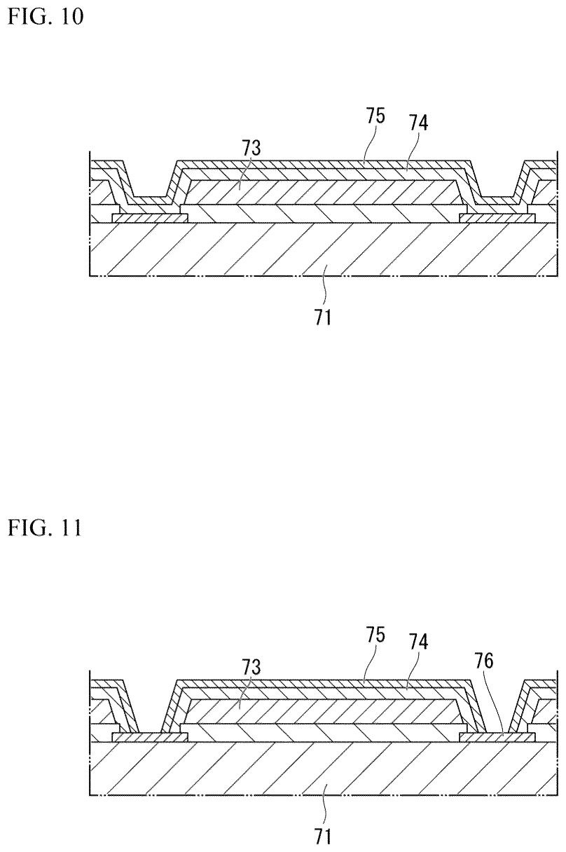

After the implementation of ST04, the manufacturer forms a second lower protective film 75 on the first lower protective film 74 as shown in FIG. 10 (ST05).

After the implementation of ST05, the manufacturer forms a first cell contact 76 on the substrate 71 as shown in FIG. 11 (ST06).

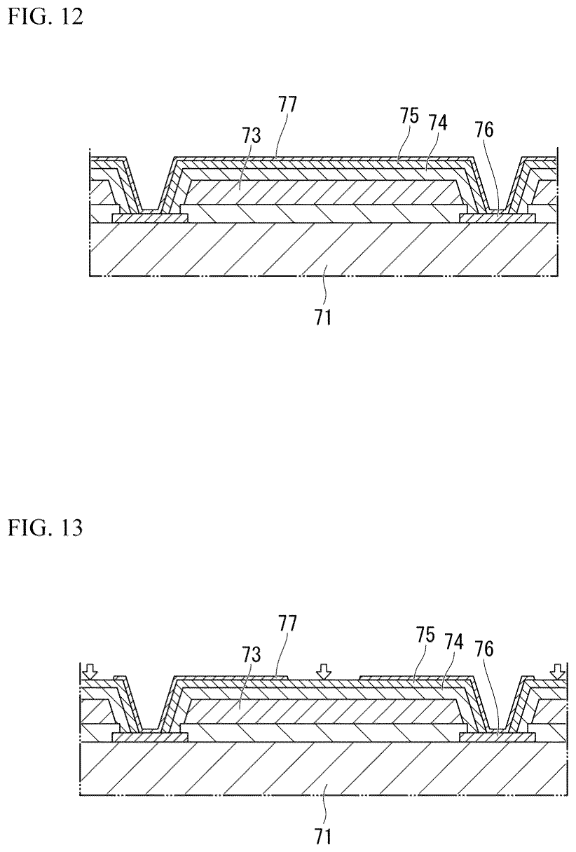

After the implementation of ST06, the manufacturer forms a TAV (Ti-6Al-4V) alloy film 77 on the second lower protective film 75 as shown in FIG. 12 (ST07).

After the implementation of ST07, the manufacturer removes the TAV alloy film 77 from a portion indicated by the arrow and performs patterning of the TAV alloy film 77 as shown in FIG. 13 (ST08). The patterned TAV alloy film 77 includes a first electrode and a second electrode configured to sandwich a meandering interelectrode region with the first electrode.

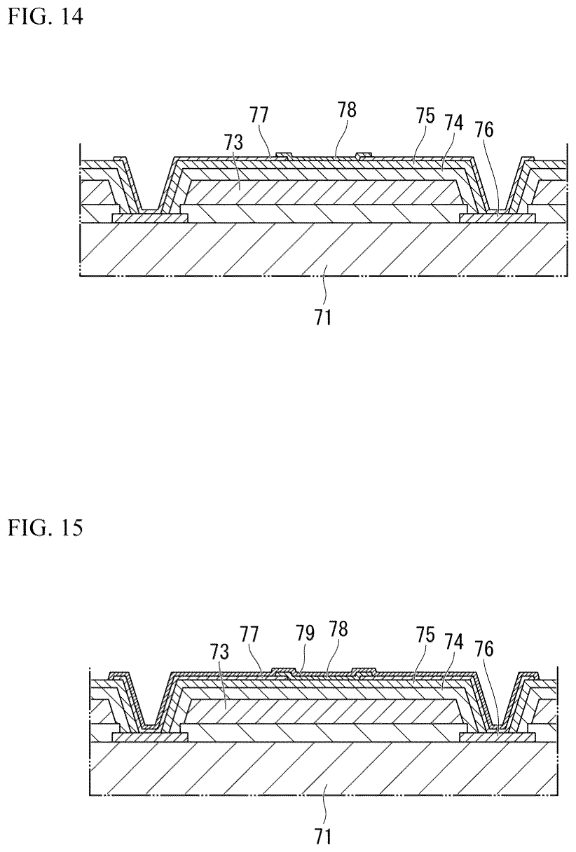

After the implementation of ST08, the manufacturer performs film formation of a carbon nanotube 78 as shown in FIG. 14 (ST09). A film of the carbon nanotube 78 is formed in at least a meandering interelectrode region provided between patterned TAV alloy films 77.

After the implementation of ST09, the manufacturer forms a first upper protective film 79 on the carbon nanotube 78 as shown in FIG. 15 (ST10).

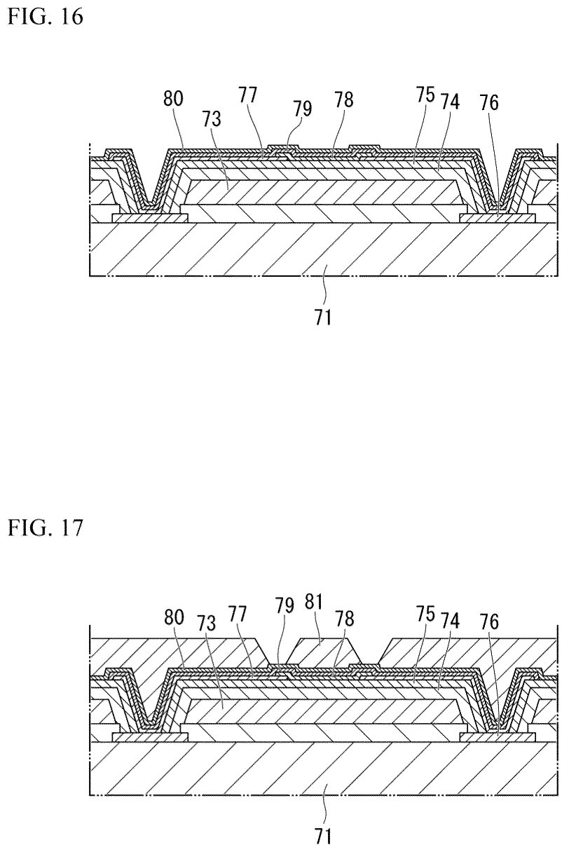

After the implementation of ST10, the manufacturer forms a second upper protective film 80 on the first upper protective film 79 as shown in FIG. 16 (ST11).

After the implementation of ST11, the manufacturer forms a second sacrificial layer 81 on the second upper protective film 80 as shown in FIG. 17 (ST12). For example, the second sacrificial layer 81 is formed of organic polyimide.

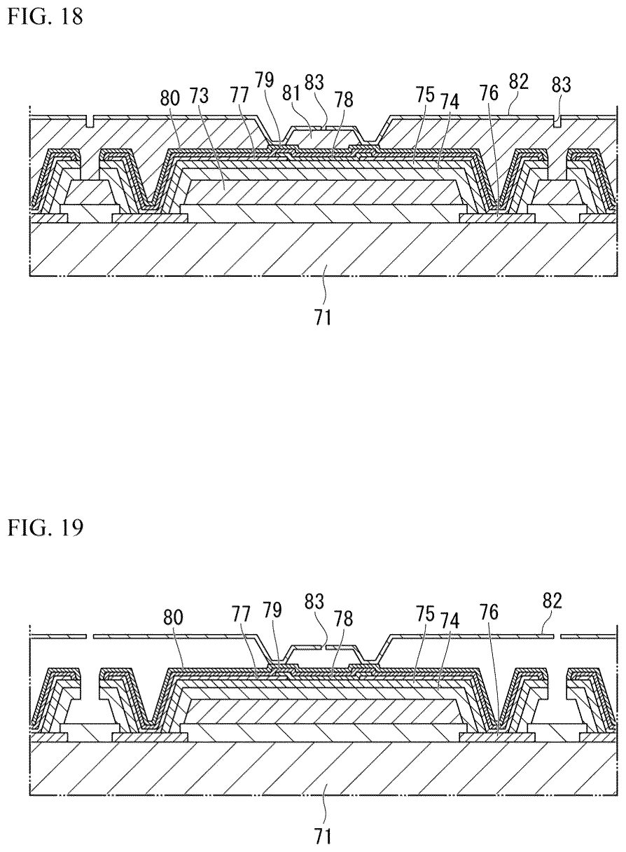

After the implementation of ST12, the manufacturer forms a light receiving layer 82 on the second sacrificial layer 81 as shown in FIG. 18 (ST13). For example, the light receiving layer 82 is formed of silicon nitride.

Further, in ST13, the manufacturer provides a through groove 83 toward the second sacrificial layer 81 on the formed light receiving layer 82. In the subsequent ST14, the through groove 83 is, for example, an opening provided so that oxygen plasma can easily enter the second sacrificial layer 81.

After the implementation of ST13, the manufacturer removes the first sacrificial layer 73 and the second sacrificial layer 81 as shown in FIG. 19 (ST14). For example, the first sacrificial layer 73 and the second sacrificial layer 81 may be selectively removed by oxygen plasma. By this removal, a structure in which the wiring portion supports the first electrode, the second electrode, and the sensor portion so that the first electrode, the second electrode, and the sensor portion are separated from the substrate is formed.

Within the bolometer manufactured in this way, the light receiving layer 82 corresponds to the light receiving portion and the connection portion of the bolometer. Moreover, the carbon nanotube 78 corresponds to the carbon nanotube film of the bolometer. Moreover, the patterned TAV alloy film 77 corresponds to the first electrode, the second electrode, the first wiring, and the second wiring of the bolometer. Moreover, the first cell contact 76 corresponds to the first contact portion and the second contact portion. Moreover, the first lower protective film 74, the second lower protective film 75, the first upper protective film 79, and the second upper protective film 80 correspond to the protective film of the bolometer.

### Operation and Effects

According to the bolometer manufactured by the manufacturing method of the present example embodiments, the interelectrode region AA in which the carbon nanotube film is electrically connected is meandering. Thereby, an electrical resistor of carbon nanotubes having a small length in a direction facing electrodes and a large length in a direction intersecting the direction facing the electrodes can be formed between the first electrode and the second electrode.

Therefore, the electrical resistance between the first electrode and the second electrode can be reduced.

### Modified Example

As long as a bolometer manufacturing method is a method by which a bolometer including a first electrode, a second electrode, a sensor portion, a wiring portion, and a protective film can be manufactured, the present disclosure is not limited to the above-described manufacturing method and any manufacturing method may be used.

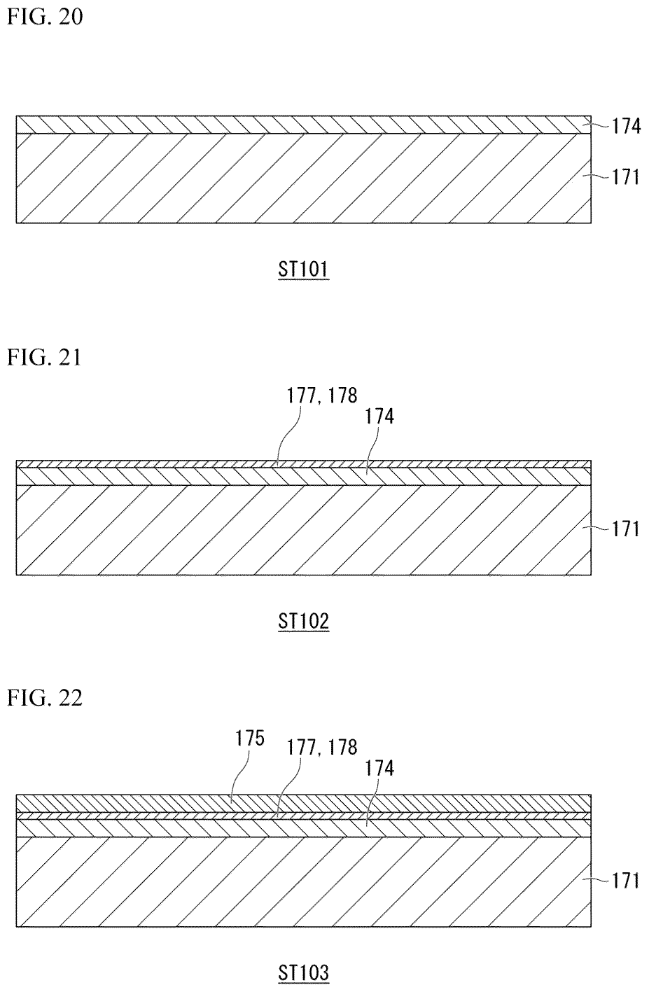

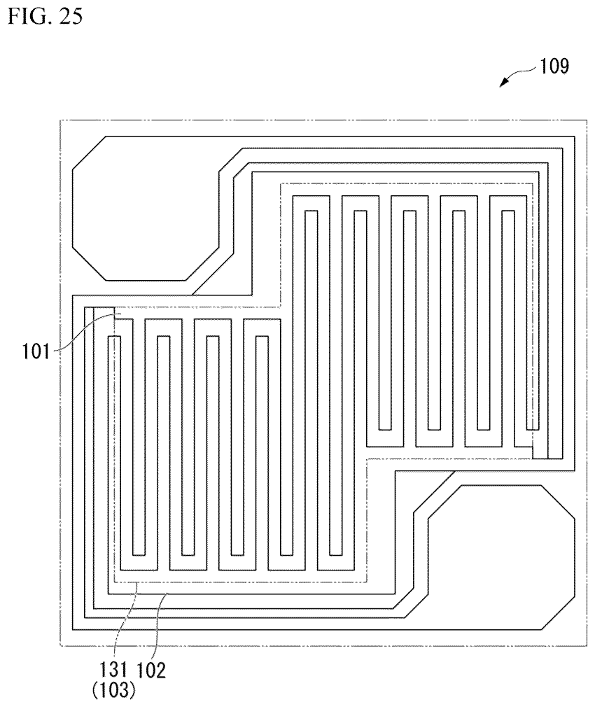

As a modified example, the bolometer manufacturing method may be performed in steps as shown in FIGS. 20 to 25.

In this modified example, first, as shown in FIG. 20, the manufacturer forms a lower protective film 174 that is an insulating film on the substrate 171 (ST101: lower protective film formation step).

After the implementation of ST102, the manufacturer forms the electrode film 177 and the carbon nanotube network film 178 on the lower protective film 174 as shown in FIG. 21 (ST102: carbon nanotube (CNT) network formation step). The electrode film 177 includes a first electrode and a second electrode configured to sandwich a meandering interelectrode region with the first electrode. The carbon nanotube network film 178 is formed in the meandering interelectrode region provided in the electrode film 177.

After the implementation of ST102, the manufacturer forms an upper protective film 175 that is an insulating film on the electrode film 177 and the carbon nanotube network film 178 as shown in FIG. 22 (ST103: upper protective film formation step). Here, a whole of the electrode film 177 and the carbon nanotube network film 178 is covered by the lower protective film 174 and the upper protective film 175.

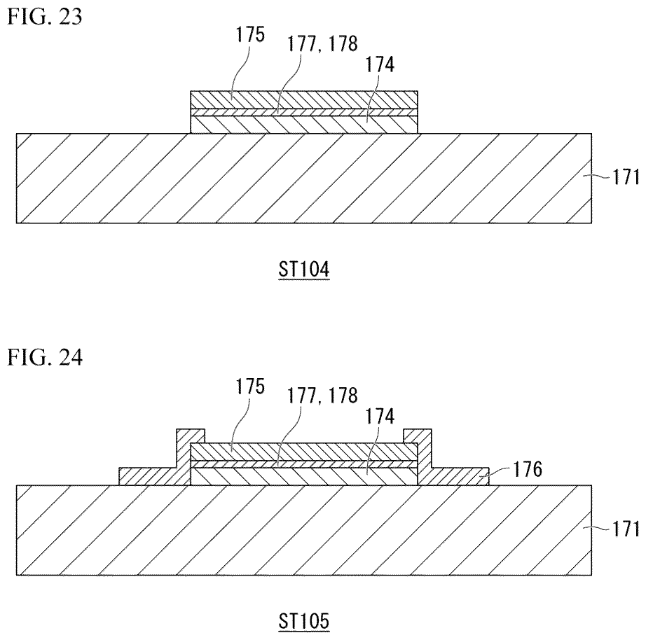

After the implementation of ST103, the manufacturer forms an exposed portion of the electrode film 177 and the carbon nanotube network film 178 on an etched end surface as shown in FIG. 23 (ST104: exposed portion formation step).

After the implementation of ST104, the manufacturer forms a contact electrode 176 as shown in FIG. 25 (ST105: contact electrode formation step). By the implementation of ST104, the electrode film 177, the carbon nanotube network film 178, and the contact electrode 176 are electrically connected in the exposed portion of the end surface.

Hereinafter, some example embodiments of the bolometer according to the present disclosure will be described.

### Configuration

The bolometer 109 includes the first electrode 101, the second electrode 102, and the sensor portion 103.

The second electrode 102 is provided to sandwich the meandering interelectrode region AA with the first electrode 101.

The sensor portion 103 includes the carbon nanotube film 131 electrically connected to the first electrode 101 and the second electrode 102 in the interelectrode region AA.

### Operation and Effects

According to the bolometer 109 of the present example embodiments, the interelectrode region AA in which the carbon nanotube film 131 is electrically connected is meandering. Thereby, an electrical resistor of carbon nanotubes having a small length in a direction facing electrodes and a large length in a direction intersecting the direction facing the electrodes can be formed between the first electrode 101 and the second electrode 102.

Therefore, the electrical resistance between the first electrode 101 and the second electrode 102 can be reduced.

Although some example embodiments of the present disclosure have been described above, these example embodiments are shown as examples and are not intended to limit the scope of the present disclosure. These example embodiments can be implemented in various other forms and various omissions, substitutions, and other modifications can be made without departing from the spirit or scope of the present disclosure. Also, each of the example embodiments can be appropriately combined with other example embodiments.

Although some or all of the above example embodiments may also be described as in the following Supplementary notes, the present disclosure is not limited to the following Supplementary notes.

### Supplementary Note 1

A bolometer including:
a first electrode;
a second electrode sandwiching a meandering interelectrode region with the first electrode; and
a sensor portion including a carbon nanotube film that is electrically connected to the first electrode and the second electrode and is provided in the interelectrode region.

### Supplementary Note 2

The bolometer according to supplementary note 1,
wherein the first electrode includes a first base end extending in a first direction and a plurality of first extension portions protruding from the first base end in a second direction intersecting the first direction,
wherein the second electrode includes a second base end extending in the first direction and a plurality of second extension portions protruding from the second base end in the second direction between the first extension portions, and
wherein the carbon nanotube film is electrically connected to the plurality of first extension portions and the plurality of second extension portions in at least a plurality of gap regions between the plurality of first extension portions and the plurality of second extensions.

### Supplementary Note 3

The bolometer according to supplementary note 1 or 2,
wherein the sensor portion further includes
a light receiving portion covering a surface side of a region including the carbon nanotube film, the first electrode, and the second electrode; and
a connection portion extending from the light receiving portion to the carbon nanotube film.

### Supplementary Note 4

The bolometer according to any one of supplementary notes 1 to 3, wherein the carbon nanotube film has: a first film side surface extending along the interelectrode region and contacting with the first electrode; and a second film side surface extending along the interelectrode region and contacting with the second electrode.

### Supplementary Note 5

The bolometer according to any one of supplementary notes 1 to 4, wherein the carbon nanotube film extends in the interelectrode region and has a meandering shape.

### Supplementary Note 6

The bolometer according to any one of supplementary notes 1 to 5, wherein the carbon nanotube film includes a carbon nanotube network film.

### Supplementary Note 7

The bolometer according to supplementary note 6, wherein a width of the interelectrode region is 500 nm or more and 3 μm or less.

### Supplementary Note 8

The bolometer according to any one of supplementary notes 1 to 7, further including a wiring portion,
wherein the wiring portion includes a first contact portion provided on a side of the second electrode, first wiring connecting the first electrode and the first contact portion, a second contact portion provided on a side of the first electrode, and second wiring connecting the second electrode and the second contact portion.

### Supplementary Note 9

The bolometer according to supplementary note 8, wherein the wiring portion supports the first electrode, the second electrode, and the carbon nanotube film.

### Supplementary Note 10

A bolometer array including:
the bolometer according to any one of supplementary notes 1 to 9, the bolometer including a plurality of bolometers; and
a substrate on which the plurality of bolometers are provided side by side.

What is claimed is:

1. A bolometer comprising:
a first electrode;
a second electrode sandwiching a meandering interelectrode region with the first electrode; and
a sensor portion including a carbon nanotube film that is electrically connected to the first electrode and the second electrode and is provided in the interelectrode region.

2. The bolometer according to claim 1,
wherein the first electrode includes a first base end extending in a first direction and a plurality of first extension portions protruding from the first base end in a second direction intersecting the first direction,
wherein the second electrode includes a second base end extending in the first direction and a plurality of second extension portions protruding from the second base end in the second direction between the first extension portions, and
wherein the carbon nanotube film is electrically connected to the plurality of first extension portions and the plurality of second extension portions in at least a plurality of gap regions between the plurality of first extension portions and the plurality of second extensions.

3. The bolometer according to claim 1,
wherein the sensor portion further includes
a light receiving portion covering a surface side of a region including the carbon nanotube film, the first electrode, and the second electrode; and
a connection portion extending from the light receiving portion to the carbon nanotube film.

4. The bolometer according to claim 1, wherein the carbon nanotube film has: a first film side surface extending along the interelectrode region and contacting with the first electrode; and a second film side surface extending along the interelectrode region and contacting with the second electrode.

5. The bolometer according to claim 1, wherein the carbon nanotube film extends in the interelectrode region and has a meandering shape.

6. The bolometer according to claim 1, wherein the carbon nanotube film includes a carbon nanotube network film.

7. The bolometer according to claim 6, wherein a width of the interelectrode region is 500 nm or more and 3 μor less.

8. The bolometer according to claim 1, further comprising a wiring portion,
wherein the wiring portion includes a first contact portion provided on a side of the second electrode, first wiring connecting the first electrode and the first contact portion, a second contact portion provided on a side of the first electrode, and second wiring connecting the second electrode and the second contact portion.

9. The bolometer according to claim 8, wherein the wiring portion supports the first electrode, the second electrode, and the carbon nanotube film.

10. A bolometer array comprising:
the bolometer according to claim 1, the bolometer including a plurality of bolometers; and
a substrate on which the plurality of bolometers are provided side by side.
